(19) United States
(12) Patent Application Publication
(10) Pub. No.: US 2007/0204741 A1
(43) Pub. Date: Sep. 6, 2007

(54) Variable Timbre Acoustic Instruments

(76) Inventor: Arturo RAMOS, Freemont, CA (US)

Correspondence Address: FOOTHILL LAW GROUP, 777 N. FIRST STREET, SUITE325, SAN JOSE, CA, 95112, US

(21) Appl. No.: 11/535,020

(22) Filed: Sep. 25, 2006

Related U.S. Application Data
(60) Provisional application No. 60/778,548, filed on Mar. 3, 2006.

(51) Int. Cl. G10D 1/08

(52) U.S. Cl. 84/291; 84/267

(57) ABSTRACT

The invention relates to an acoustic musical instrument whose timbre can be varied while playing the instrument.

The acoustic musical instrument comprises a membrane and a body which body forms a cavity therein, a divider means within the body cavity, said divider means defining an aperture therethrough, wherein the divider separates the body cavity into a first zone and a second zone such that the first zone and second zone are capable of tonal communication through the aperture, a moveable cover, said cover capable of adjustably blocking the aperture; and a movement device, which is capable of moving the moveable cover under control of a user.

This application claims the benefit of my Provisional Application 60/778,548 filed on Mar. 3, 2006, which is hereby incorporated herein by reference.

### BACKGROUND OF THE INVENTION

1. Field of the Invention

The field of the invention is acoustic musical instruments, particularly stringed instruments and percussion instruments.

2. Description of the Prior Art

“Acoustic instruments” in this application refers to musical instruments which do not produce sound using electronics, as does an electronic musical instrument. Electric instruments include both electronic instruments and electrically amplified acoustic instruments. Acoustic instruments comprise a resonator structure and a driver. Acoustic instruments include string instruments, percussion instruments, and wind instruments. In particular the instant invention is directed towards instruments comprising a membrane and a hollow body, such as string instruments and percussion instruments.

In a guitar, for example, the membrane is the soundboard on the guitar. The soundboard has a sound hole therein. The guitar also has a hollow body wherein the soundboard is the top side. The soundboard and the body make up the resonator. The strings are the driver. The strings are positioned between the head of the guitar and a bridge and saddle on the soundboard which transmits the vibration of the strings to the soundboard. The strings are attached to tuning heads on the head of the guitar by which the tension on the strings may be adjusted.

In a drum, the membrane is a drumhead which is attached to a hollow body. A drum body may have practically any shape, though many are cylindrical. Cylindrical drums, as well as any drum with two ends, may optionally have two membranes, one at either end. Alternatively, one end may be uncovered. Some drums have only one end, such as drums with a bowl shaped body, such as timpani or kettle drums, with a membrane covering a kettle. The drivers for drums are typically drumsticks or the player's hands.

The tonal quality (timbre) of a percussion or string instrument is strongly influenced by the size and form of the hollow body in which sound waves resonate. For this reason there are different sizes and shapes of instruments, and a musician is often required to switch instruments in a single performance to achieve different effects.

There is a need to improve acoustic instruments by allowing the musician to adjust the resonant tone of a single instrument.

### SUMMARY OF THE INVENTION

The embodiments of the invention allow a musician to adjust the timbre of a single acoustic instrument in a manner similar to switching from one instrument to another instrument having a different size and/or shape of body. Timbre is defined as that attribute of sensation in terms of which a listener can judge that two sounds having the same loudness and pitch are dissimilar.

The acoustic instrument has, at minimum, a hollow resonant body and a membrane (for example, the drum head on a drum or the soundboard on a string instrument). The membrane transfers vibration from drivers to the hollow body in which sound waves resonate. The improvement is to divide the body into at least two zones with a divider, which divider comprises an aperture that goes through the divider from one zone to the other. The divider seals between the zones except for the aperture. A moveable cover is included, which is configured to cover the aperture either not at all, partially or totally. A movement device is included which moves the cover under user control. Depending on the position of the cover the instrument has a different tonal quality.

One preferred embodiment is an improved acoustic guitar. In acoustic guitars, string vibration is transmitted through a bridge and saddle to a sound board. The sound board, typically made of a light springy wood such as spruce, vibrates the air, producing sound which is further shaped by the guitar body's resonant cavity. Guitar strings are strung parallel to the neck of the guitar, whose surface is covered by the fingerboard (fret board). By depressing a string against the fingerboard, the effective length of a string can be altered, which in turn determines the frequency at which the string will vibrate when plucked. The guitar includes a sound hole out of which the sound comes. A preferred embodiment for a guitar includes a divider which is a parallelepiped box with preferably rectangular sides. The box is attached to the inside of the soundboard covering the sound hole, so as to form a second resonant cavity. The aperture is on the side of the box opposite from the sound hole. The guitar further includes a cover and a movement device within the box. The cover is located inside the box on the side with the aperture, preferably contained within rails, whereby it may slide to cover part or the entire aperture. The movement device is preferably a handle extending from the cover, through a slot on the soundboard and out of the guitar so that it may be used to slide the cover over the aperture. When the aperture is uncovered the timbre of the improved guitar has close to that of the original guitar without the divider. When the aperture is filly covered the timbre is much different corresponding to a guitar with a smaller resonant body.

The improvement may have many different shapes and sizes for string instruments, the key elements being that the divider be a three dimensional container so as to form a second resonant cavity when the aperture is covered, with an aperture opposite the sound hole, a cover capable of covering the aperture, and a movement device capable of moving the cover under control of a user.

Another preferred embodiment is an improved drum. Drums may have many sizes and shapes of their body and may have one or two membranes. The invention works with any configuration. For example, choose a cylindrical body drum with resilient membranes on both sides of the cylinder. The improved drum comprises a divider which in this case is simply a flat plate sealaby attached to the inside of the cylindrical body somewhere between the two ends of the body so as to divide the body into two zones. The divider defines an aperture through the divider connecting the two zones. The improved drum further comprises a moveable cover which is adapted so as to cover over part or the entire aperture, and a movement device which moves the cover. In a preferred embodiment, the cover is a first gear with an opening through it. The gear is rotated by a second gear intermeshed with the first gear which extends outside of the body of the drum so it can be manipulated. The divider is a plate which has an opening corresponding to the opening in the first gear, so that depending on the position of the first gear, the opening in the divider is either open or closed or partially open.

### BRIEF DESCRIPTION OF THE DRAWINGS

These and other features, aspects and advantages of the present invention will become better understood with regard to the following description, appended claims and accompanying drawings, where:

FIG. 1 is a perspective view of an improved guitar according to the invention.

FIG. 2 is a top view of the improved guitar.

FIG. 3 is a top view of the divider and cover.

FIG. 4 is a side view of the cover,

FIG. 5 is a side view of an improved drum according to the invention.

FIG. 6 is a top view of the rotating gear and divider assembly.

### DESCRIPTION

The invention enables a single acoustic musical instrument, such as but not limited to a guitar or a drum, to produce at least two distinct timbres, the improvement comprising a divider which divides the body, that is, the resonant cavity of the instrument, into at least two chambers. The divider has an aperture through it. The improvement further comprises a moveable cover which can be positioned to obscure part or all of the aperture and a movement device, extending outside the instrument, which moves the cover under operator control. Thus when the cover does not obscure the aperture, the chambers communicate through the aperture and the full volume of the resonant cavity is available. However, when the aperture is obscured by the cover only part of the resonant cavity is available to the sound quality.

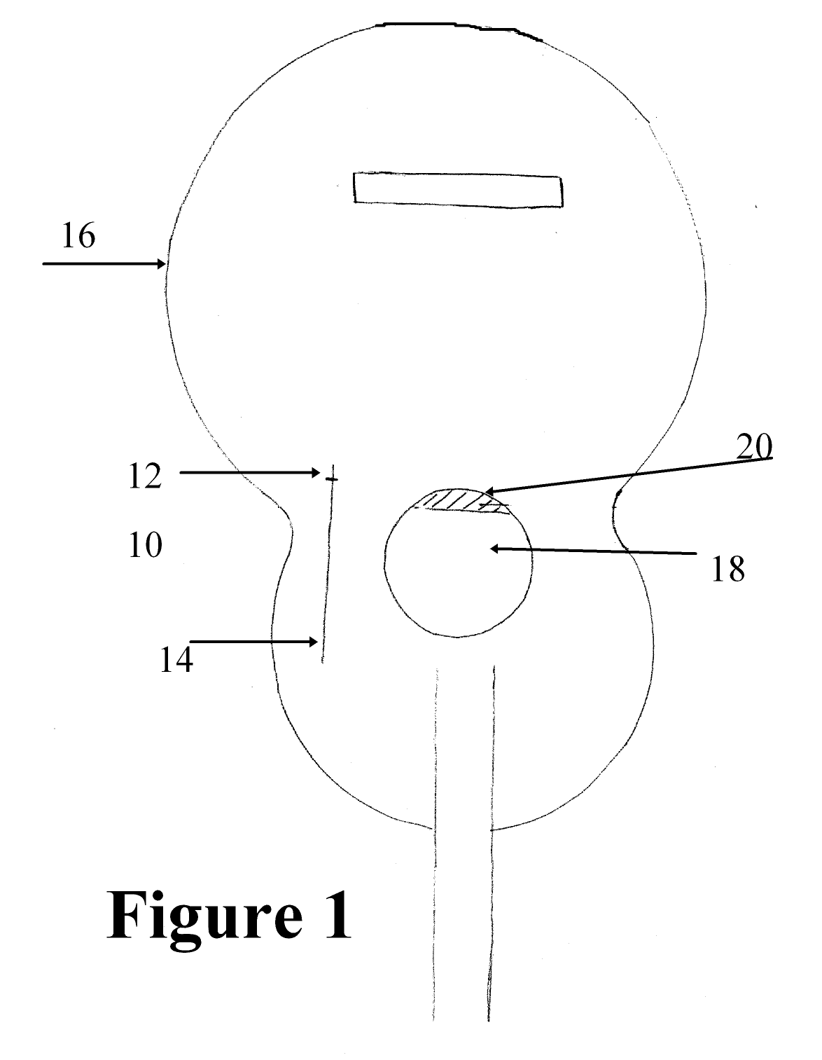

FIG. 1 shows a top view of a preferred embodiment of the invention applied to a guitar 10. The soundboard 16 has a slot 14, and a handle 12 extending through the slot. A portion of the aperture (in line with the sound hole) is obscured by a portion of the moveable cover 20.

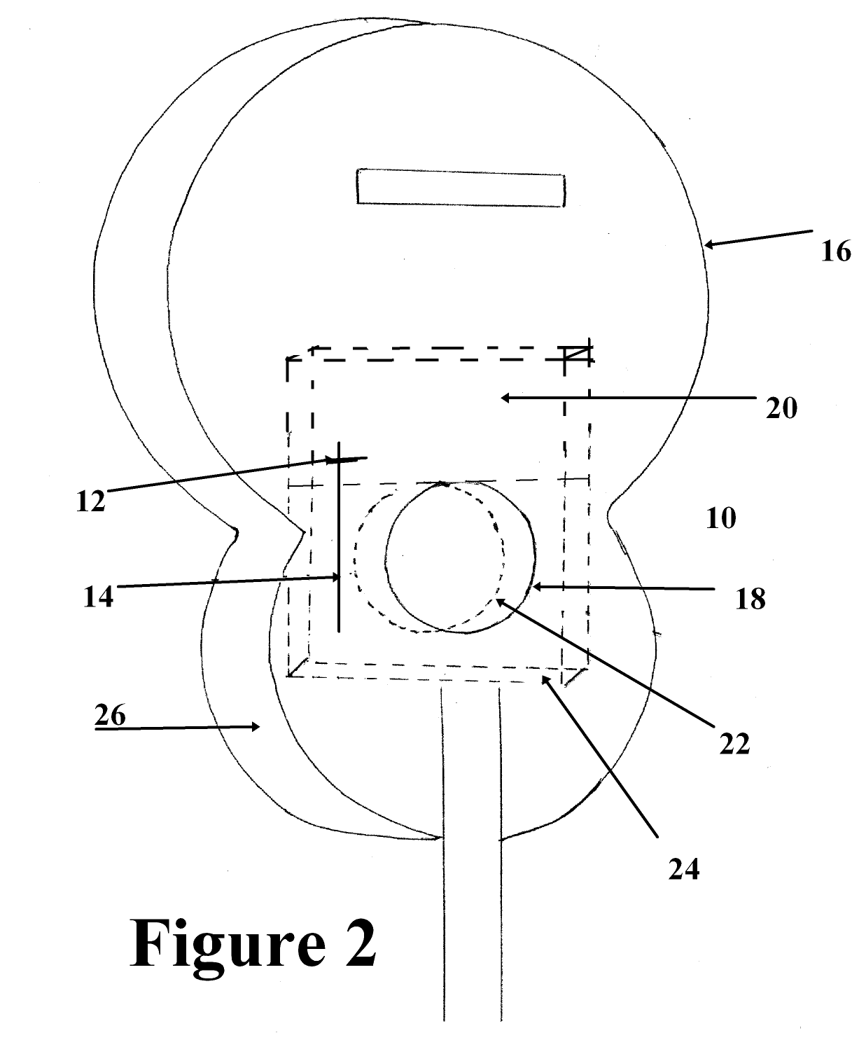

FIG. 2 is a perspective view of the guitar, showing the divider 24, a rectangular parallelepiped box which is glued to the inside of the soundboard. The aperture in the divider 22 is shown in vertical alignment with sound hole 18. This is the preferred configuration but alignment is not required. The slot 14 extends through the soundboard. The movement device, a handle 12 begins at the cover 20 and extends through the slot. The cover 20 can be moved so as to cover the entire aperture or any part or none of it. The divider 24 is inside the body 26 of the guitar. If the cover is positioned to obscure the aperture then the resonant body is effectively limited the volume of the parallelepiped box. If the aperture is open then the entire body 26 of the guitar is available for sound to resonate. By moving the cover the timbre of the guitar is modified.

FIG. 3 is a top view of the bottom of the divider, showing the cover 20 contained on rails 32 so that it can be slid over aperture 22.

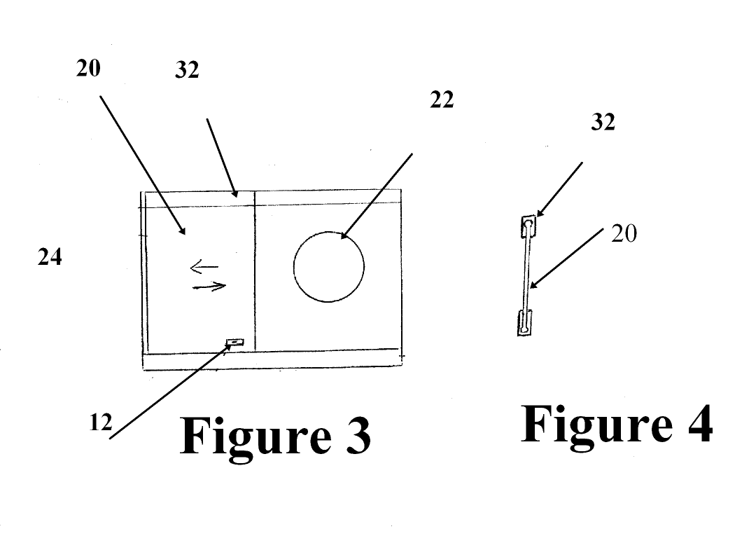

FIG. 4 is a side view showing the cover 20 moving in rails 32.

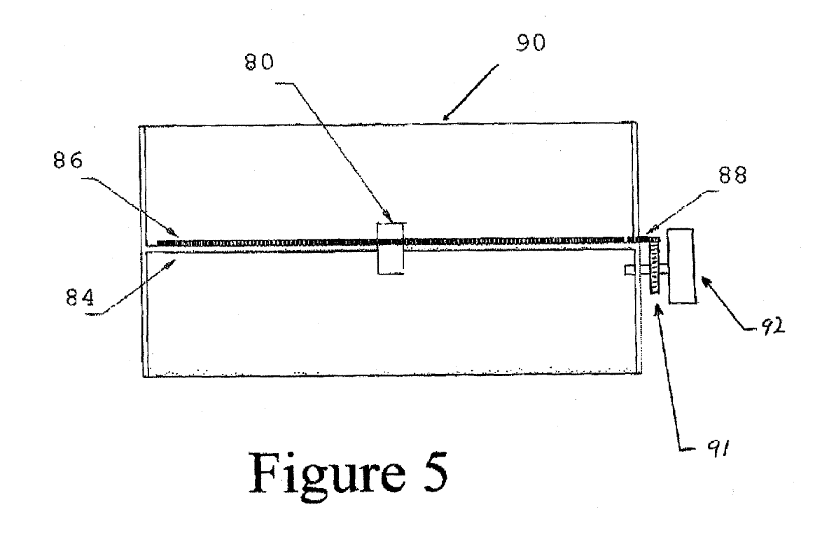

FIG. 5 shows another preferred embodiment of the invention, drum. The drum is separated into two parts separated by divider 84 and a top membrane 90. The divider is covered by a first gear 86 which can rotate around center pin 80. The first gear is rotated by means of intermeshed second gear 88. Rotation of gear 88 is facilitated by a third gear 91, which is operated by knob 92.

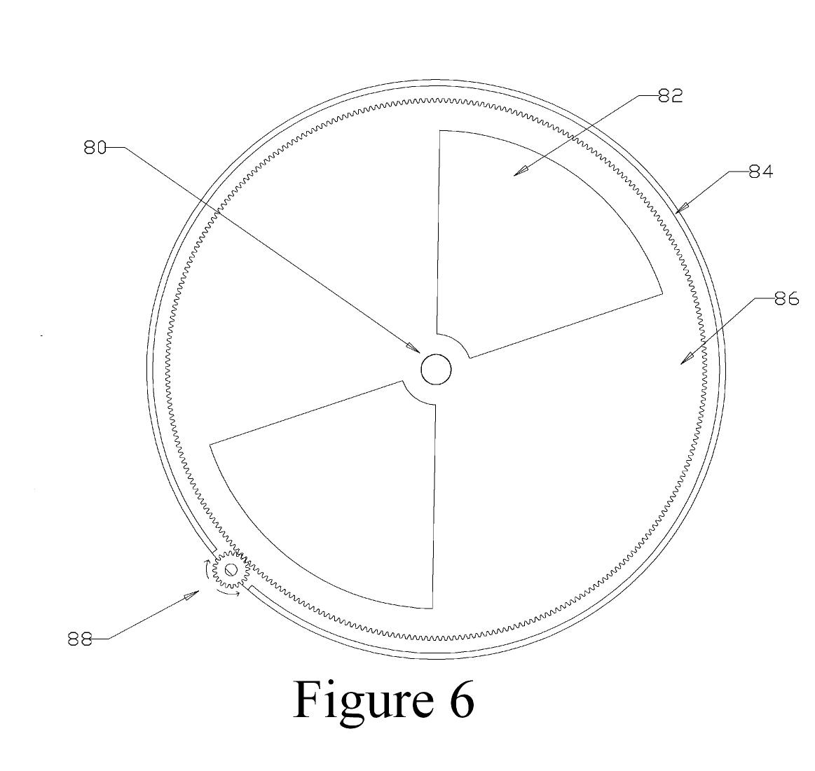

FIG. 6 shows that both the divider 84 and the first gear 86 have corresponding openings 82, whereby the opening in the divider may be obscured or exposed depending on how the cover is rotated. If the opening is exposed the resonant chamber is the whole drum body, however if the opening is obscured the resonant chamber is just the top portion. A musician can vary the timber of his or her percussion instrument by varying the portion of the aperture which is exposed by the moveable cover. The musician does this by manipulating the movement device (e.g., the handle or small gear) which extends outside the instrument.

Although the present invention has been described in considerable detail with reference to certain preferred versions thereof, other versions are possible. Therefore the spirit and scope of the appended claims should not be limited to the preferred versions herein.

I claim:

1) In an acoustic musical instrument comprising a membrane and a body which body forms a cavity therein, the improvement comprising:
a) a divider means within the body cavity, said divider means defining an aperture there through, wherein the divider separates the body cavity into a first zone and a second zone such that the first zone and second zone are capable of tonal communication through the aperture;
b) a moveable cover, said cover capable of adjustably blocking the aperture; and
c) a movement device, which is capable of moving the moveable cover under control of a user.

2) The acoustic instrument of claim 1, wherein the acoustic instrument is a stringed instrument.

3) The acoustic instrument of claim 2, wherein the acoustic instrument is a guitar.

4) The acoustic instrument of claim 3, wherein membrane comprises a soundboard on the body and soundboard has a sound hole there through, the soundboard having an inside and an outside, wherein the divider means comprises a three dimensional container, the container which is sealably attached to the inside of the soundboard surrounding the sound hole.

5) The acoustic instrument of claim 4, wherein the three dimensional container is a parallelepiped consisting of rectangular sides, and wherein the aperture is circular and is positioned through the side of the parallelepiped opposite the soundboard.

6) The acoustic instrument of claim 5, wherein the moveable cover is a flat cover which is larger than the aperture.

7) The acoustic instrument of claim 6, wherein the soundboard defines a slot there through, and the movement device comprises a handle which is attached to the flat cover on one end of the handle, and extends through the slot on the other end, whereby the cover may be moved to a position so as to obscure any part of the aperture by moving the movement device, and the tone quality will vary with the position of the cover.

8) The acoustic instrument of claim 1, wherein the acoustic instrument is a drum.

9) The acoustic instrument of claim 1, wherein the membrane is at one end of the body and wherein the drum further comprises a second membrane at a second end of the body.

10) The acoustic instrument of claim 8, wherein the divider means comprises a flat object sealably attached attached across a cross-section of the body of the drum and defining an aperture therethrough.

11) The acoustic instrument of claim 10, wherein the moveable cover is a first gear covering the divider means, the cover defining an aperture corresponding to the aperture in the divider means.

12) The acoustic instrument of claim 11, wherein the movement device comprises a second gear intermeshed with the first gear, the second gear extending out of the body, whereby the cover may be moved to a position so as to obscure any part of the aperture by rotating the second gear, and the tone quality will vary with the position of the cover.

13) A method of changing the timbre of a percussion instrument, comprising the steps of:
a) providing an acoustic musical instrument comprising a membrane and a body which body forms a cavity therein, a divider means within the body cavity, said divider means defining an aperture therethrough, wherein the divider separates the body cavity into a first zone and a second zone such that the first zone and second zone are capable of tonal communication through the aperture, a moveable cover, said cover capable of adjustably blocking the aperture; and a movement device, which is capable of moving the moveable cover under control of a user;
b) manipulating the movement device to move the cover such that if the aperture is exposed to move the cover to obscure the aperture and if the aperture is obscured to move the cover to expose the aperture.
